(19) United States
(12) Patent Application Publication
(10) Pub. No.: US 2026/0129431 A1
(43) Pub. Date: May 7, 2026

(54) TECHNIQUES FOR AN ACCESS POINT OF A WIRELESS LOCAL AREA NETWORK (WLAN) TO PRESERVE ASSOCIATION IDENTIFIER (AID) DOMAIN SPACE

(71) Applicant: Cisco Technology, Inc., San Jose, CA (US)

(72) Inventors: Domenico Ficara, Essertines-sur-Yverdon (CH); Ugo Mario Campiglio, Morges (CH); Jerome Henry, Pittsboro, NC (US); Javier I. Contreras Albesa, Sant Cugat del Valles (ES)

(21) Appl. No.: 19/254,301

(22) Filed: Jun. 30, 2025

Related U.S. Application Data
(60) Provisional application No. 63/717,436, filed on Nov. 7, 2024.

(51) Int. Cl. H04W 12/02

(52) U.S. Cl. CPC H04W 12/02

(57) ABSTRACT

An access point computes, for user devices in each group of a plurality of groups of user devices, a plurality of start times of future enhanced data privacy (EDP) epochs during which identifiers from the user devices in each group are to be rotated. Based on the plurality of start times, it is determined that transitory periods will occur at a same time for at least a threshold number of groups of the plurality of groups of user devices. The AP transmits a message to user devices in at least one group of the at least a threshold number of groups instructing the user devices to perform one or more actions to prevent the transitory periods from occurring at the same time.

### CROSS REFERENCE TO RELATED APPLICATION

This application claims priority to U.S. Provisional Application No. 63/717,436, filed November 7, 2024, the entirety of which is incorporated herein by reference.

### TECHNICAL FIELD

The present disclosure relates to wireless network equipment and services.

### BACKGROUND

Networking architectures have grown increasingly complex in communications environments, particularly in wireless networking environments. For wireless local area networks (WLANs), Institute of Electrical and Electronics Engineers (IEEE) 802.11 specifications are working toward defining mechanisms to preserve the privacy of a station (STA) by preventing eavesdroppers from tracking the station. Thus, there are new challenges and opportunities with regard to preserving the privacy of stations within WLANs.

### BRIEF DESCRIPTION OF THE DRAWINGS

FIG. 1 is a block diagram of a system that may be implemented to facilitate techniques for an access point of a wireless local area network (WLAN) to preserve association identifier (AID) domain space, according to an example embodiment.

FIG. 2 is a diagram illustrating an example in which enhanced data privacy (EDP) epochs for EDP groups include overlapping transitory periods, according to an example embodiment.

FIG. 3 is a graph illustrating simulation results for a number of groups of stations (STAs) for an AID pool, according to an example embodiment.

FIG. 4 is a flow chart of a method of performing one or more actions to prevent transitory periods in a plurality of EDP groups from occurring at the same time, according to an example embodiment.

FIG. 5 illustrates a hardware block diagram of a computing device configured to perform functions associated with operations discussed in connection with embodiments herein.

### DETAILED DESCRIPTION

### Overview

In one embodiment, a method is provided for performing one or more actions to prevent transitory periods in a plurality of enhanced data privacy (EDP) epochs in a plurality of EPD groups from occurring at the same time. An access point (AP) computes, for user devices in each group of a plurality of groups of user devices, a plurality of start times of future enhanced data privacy (EDP) epochs during which identifiers for the user devices in each group are to be rotated. Based on the plurality of start times, it is determined that transitory periods will occur at a same time for at least a threshold number of groups of the plurality of groups of user devices. The transitory periods are periods of time in which first identifiers assigned during a previous EDP epoch are accepted for received data units and second identifiers assigned during a current EDP epoch are used for data units that are transmitted. The AP transmits a message to user devices in at least one group of the at least a threshold number of groups instructing the user devices to perform one or more actions to prevent the transitory periods from occurring at the same time.

### Example Embodiments

Embodiments herein provide techniques that allow access points (APs) for a wireless local area network (WLAN), such as an Institute of Electrical and Electronics Engineering (IEEE) 802.11 (Wi-Fi®) WLAN, to control the association identifier (AID) domain space that may be impacted by enhanced data privacy (EDP) transitory periods overlapping across one or more EDP groups.

In a wireless local area network (WLAN) or Wi-Fi network, one or more wireless APs provide wireless Radio Frequency (RF) coverage over which one or more wireless devices or stations can connect to the APs in order to connect to one or more data networks (e.g., the public Internet, an enterprise network operated by an enterprise entity (e.g., a business, institution, university, etc.)), and/or the like. Current WLAN/Wi-Fi standards, such as Institute of Electrical and Electronics Engineers (IEEE) 802.11 standards, including IEEE 802.11bi, are working steadily towards the definition of mechanisms to preserve a station’s privacy by preventing eavesdroppers from tracking the station.

To prevent eavesdroppers from tracking stations, elements (e.g., identifiers) in frames exchanged between a station and the AP are anonymized. One of the elements that is anonymized is an association identifier (AID). The AID is an identifier identifying an association between an access point and a user device or station (STA) in which the AID is assigned to a user device or STA by an access point. Typically, the AID has a smaller number of bits than other identifiers associated with a STA. For example, the AID may be an 11-bit field or a 16-bit field and, when the AID is a 16-bit field, the values that may be assigned to a STA range from 1 to 2007. The AID, like other frame parameters in IEEE 802.11bi (such as Media Access Control (MAC) addresses), is changed or rotated at each of an enhanced data privacy (EDP) epoch. In other words, the AID associated with a station is changed at each EDP epoch to prevent eavesdroppers from associating a particular AID with a station.

In recent 802.11 work, the cost of transitory periods in EDP epochs has been explored. A transitory period is a time at a start of an EDP epoch (e.g., EDP epoch K+1) during which an old AID (e.g., an AID associated with a station during EDP epoch K) is still used for data units received at the AP, but a new AID (e.g., an AID assigned to the station during epoch K+1) is used for new transmissions. It would be useful to be able to receive all frames that have been enqueued in epoch K, with the previous AID marking. However, receiving frames with old AID markings has repercussions beyond the mere transient. For example, triggered multi-packet exchanges may start in one epoch and finish in the next epoch. As described below, this constraint means that, effectively, only half of the total set of AIDs can be used in any epoch, for each EDP group.

If there is a single EDP group (i.e., all stations associated with an AP are in a single EDP group and change their AIDs at the same time and at the beginning of each new EDP epoch), then only half of the maximum number of AID values are available to a station at a time. For example, if the maximum number of available AID values is 2000, then only 2000/2= 1000 AIDs are unused and available to an AP to assign to user devices/stations. The 1000 AIDs are assigned, and at the beginning of the next epoch, these 1000 AIDs cannot be immediately reused (because the AIDs from the previous epoch are still being used for received frames), effectively blocking them from use, and limiting the AP to the next 1000 AIDs.

As discussed above, because the number of bits in the AID is small, there are approximately 2000 AID values available to an AP to assign to stations. Thus, from a maximum of 2000 AIDs, the BSS (Basic Service Set) is effectively limited to half that capacity. If the potential support of legacy stations by the same AP is considered, this number can be halved again (e.g., if 1000 STAs are legacy and use a static AID, and the AP has only 1000 AIDs left for 802.11bi stations that rotate AIDs, the number of AIDs to assign to the 802.11bi stations is limited to a maximum of 500). The limited number of AIDs to assign to stations can be a problem because it limits the ability of the AP to scale wireless access support.

On the other hand, 802.11bi supports multiple EDP groups. For example, a single AP may be associated with multiple EDP groups, each EDP group including multiple stations. The AP may calculate start times for EPD epochs on a group-by-group basis using a pseudo-random function with different input parameters. In other words, the start times of EPD epochs are determined for STAs in each group and the start times for the EDP epochs are the same for the STAs in each group. Therefore, stations in a single EDP group may change their AID values at the same time (i.e., at the start of each EDP epoch), but since the start times of EDP epochs for different EPD groups are calculated separately, stations in different groups may change their AID values at different times. Since the different EDP groups have different EDP epochs, one potential strategy to preserve AID domain space is to have stations distributed across multiple groups (e.g., spread across 'N' groups).

However, even if all stations are spread across N groups, because the start time of an EDP epoch is defined as a pseudo-random function, overlap of the transitory period for a large number of groups can occur with some probability. Because, as described above, each overlap costs two times the number of AIDs, this has a large impact on AP operations (even if with a low probability), potentially causing a DoS (Denial of Service).

Embodiments described herein solve this problem by providing techniques to allow APs to control an AID domain space that may be impacted by EDP transitory periods overlapping across EDP groups. According to the embodiments herein, an AP may compute start times for a number of future EDP epochs in different EDP groups using a pseudo-random function (PRF). If the AP determines that an overlap in transitory periods will occur for a particular (e.g., a threshold) number of groups, the AP performs an action to prevent the overlap in at least some of the transitory periods from occurring. In some embodiments, the action may include, for example, sending a message (e.g., an action frame) to stations in some of the groups instructing the stations to extend an EDP epoch to the end of a next epoch or force an epoch change at an earlier or later time. In some embodiments, the action includes sending a message to stations in some of the groups with PRF parameters and a request to recompute start times of epochs using the PRF parameters. In other embodiments, the action includes sending a message to stations in some of the groups instructing the stations not to rotate their AIDs for the EDP epoch associated with the overlapping EDP transitory period.

Thus, present embodiments improve the technical field of client device identifier rotation in a wireless network by identifying when an overlap of transition periods at the beginning of EPD epochs are going to occur for a particular number of EDP groups and performing actions to prevent the overlap from occurring for at least some of the EDP groups. Present embodiments therefore decrease negative impacts on access point operations by limiting a number of concurrent transitory periods among EPD groups during which a large number of AIDs would be unavailable for assigning to user devices/stations. Thus, present embodiments provide the practical application of an access point that computes start times of EDP epochs for a number of EDP groups, identifies when an overlap in the transitory periods will occur for a threshold number of EDP groups, and performs actions to prevent the overlap from occurring for at least some of the EDP groups. By preventing the overlap from occurring for at least some of the EDP groups, a large enough number of unused AID values are available to assign to client devices/stations, which prevents issues (e.g., a Denial of Service) from occurring and allows the access point to scale wireless access support.

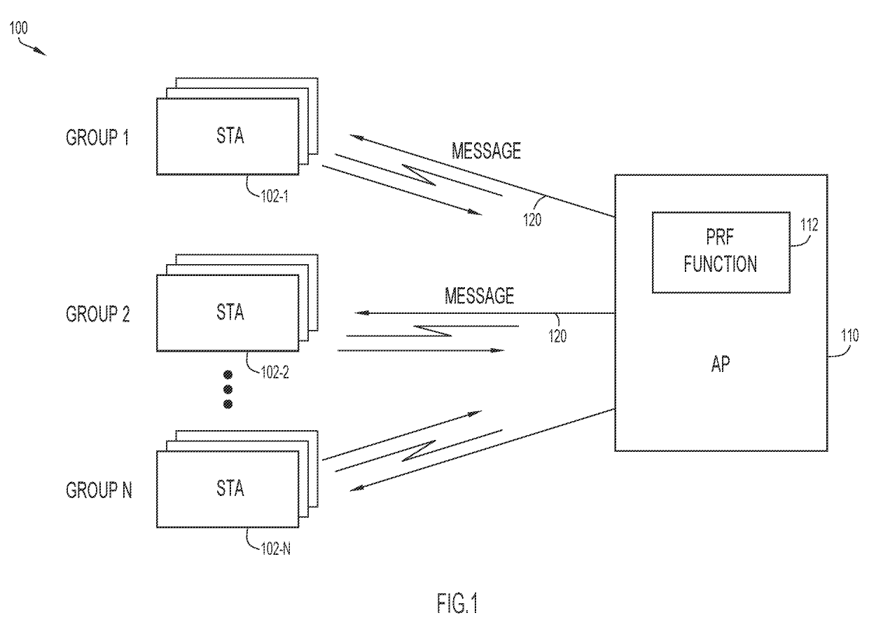

Referring to FIG. 1, FIG. 1 is a block diagram of a system 100 that may be provided to facilitate techniques for an access point to preserve association identifier (AID) domain space, according to an example embodiment. In at least one embodiment, system 100 may include a WLAN that includes one or more stations (STAs) 102-1, 102-2, …, 102-N and at least one wireless access point (AP) 110. As illustrated in FIG. 1, STA 102-1 may be one of a plurality of STAs in a first group (Group 1), STA 102-2 may be one of a plurality of STAs in a second group (Group 2), and STA 102-N may be one of a plurality of STAs, in a Nth group (Group N). As used herein, ‘STA 102-1’ may refer to the plurality of STAs in Group 1, ‘STA 102-2’ may refer to the plurality of STAs in Group 2, and ‘STA 102-N’ may refer to the plurality of station in Group N. STAs 102-1 to 102-N may also be referred to herein as ‘user devices’, 'clients', 'client devices', 'stations', and variations thereof.

STAs 102-1 to 102-N may include user devices (e.g., tablets, laptop computers, Smartphones, or any user device now known or hereinafter developed) that can access a data network, such as the Internet, using a wireless network, a wide area network, or another wireless network. AP 110 provides RF coverage over which STAs 102-1 to 102-N can connect to the AP in order to connect to the data network.

STAs 102-1 to 102-N may access networks or services by exchanging data units or frames with AP 110. For example, STAs 102-1 to 102-N may transmit frames to AP 110 for communicating with one or more networks and AP 110 may receive data units destined for STAs 102-1 to 102-N from the one or more networks and transmit frames to the STAs 102-1 to 102-N. To preserve privacy associated with STAs 102-1 to 102-N and to prevent eavesdropper from tracking STAs, elements (e.g., identifiers) in the frame may be rotated or changed periodically. For example, the elements may be changed at each EDP epoch. One element that may be changed or rotated is the AID associated with the STAs. In other words, at the start of each new EDP epoch, the AID associated with each STA may be changed or rotated.

As discussed above, at the beginning of each EDP epoch, there is a transitory period during which the AID from the previous EDP epoch is accepted for a STA, but transmissions associated with the STA use the AID assigned during the current EDP epoch. During the transitory period, each STA may be associated with two AIDs (i.e., the AID from the previous EDP epoch and the AID from the current EDP epoch). Since each STA is associated with two AIDs, the total number of unused AIDs (AIDs from which to choose new AIDs for the STAs) is halved.

The start time for each new EDP epoch is using a pseudo-random function (PRF). For example, AP 110 and STAs 102-1 to 102-N may use the PRF and input parameters to compute start times for EDP epochs. Different input parameters may be used for computing the start times of the EDP epochs for each group. STAs in each group may use the input parameters and PRF to compute the start times for the new EDP epochs. AP 110 may additionally compute the start times of the EDP epochs for STAs in each group.

As noted above, by spreading STAs across multiple EDP groups (e.g., Group 1, Group 2, …, Group N), the cost of an EDP epoch transitory period can be reduced. For example, by using different input parameters, different EDP epoch start times may be computed for each group of STAs. In other words, STAs in the same EDP group will change AID values at the same time (i.e., the start of a new EDP epoch), but start times for EDP epochs for STAs in different EDP groups are usually not the same. In this way, transitory periods in different groups usually do not overlap. However, there is a probability that a subset of all EDP groups may have a simultaneous transitory period at a certain moment of time. The probability of simultaneous transitory periods occurring depends on a number of different factors such as the PRFs (or their input parameters) used to compute the start time of EDP epochs for each EDP group, the duration of different EDP group epochs, the number of EDP groups, how long a transitory period is, etc.

An AP 110 has little control over the above factors after the establishment of the EDP epochs. In addition, even if the AP 110 is able to control the timing of the next foreseeable EDP epochs, there is a chance that the transitory period of a subset of epochs will overlap. When the subset of EDP epochs is large enough, despite the effort of spreading STAs around into different groups, there may be a price to pay for reserving a number of AIDs as big as twice the number of STAs in those groups.

Even if the probability 'p' of the transitory periods occurring simultaneously is relatively low, the probability that it will not occur in a large number (N) of epoch tends to 0, as follows:

(1-p)^N -> 0

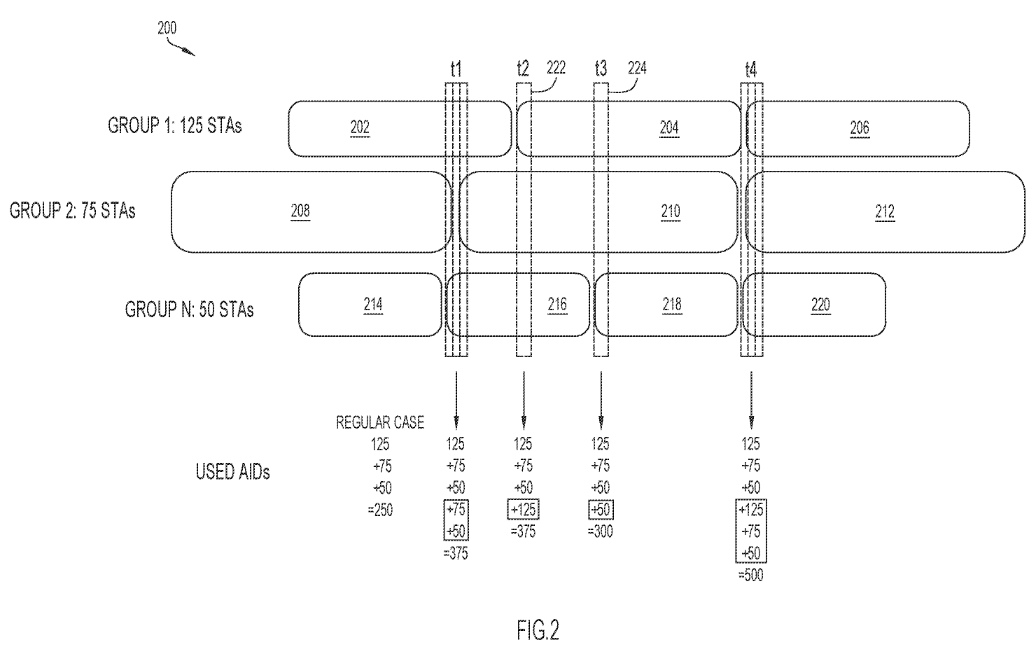

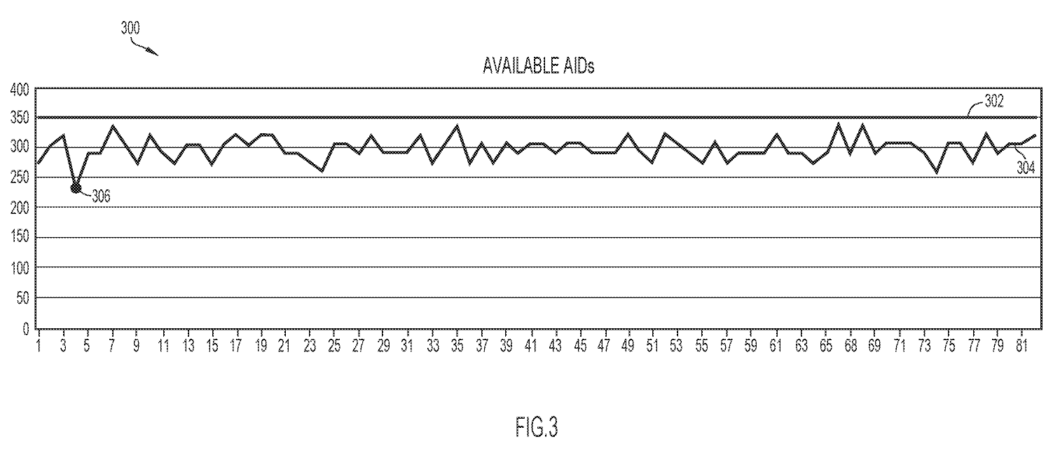

This may be analogous to saying that the probability that such a low-probability event will occur may tend to be 1 in the long run. In other words, at some point, the transitory periods may overlap for STAs in multiple groups. As described further below with respect to FIGS. 2 and 3, overlapping transitory periods result in fewer available AIDs for assigning to STAs.

Reference is now made to FIG. 2. FIG. 2 is a diagram 200 illustrating an example in which EDP epochs for Group 1, Group 2, and Group N include overlapping transitory periods.

As illustrated in FIG. 2, Group 1 includes 125 STAs, Group 2 includes 75 STAs, and Group N includes 50 STAs. The start times of EDP epochs 202, 204, and 206 have been computed for STAs in Group 1, the start times of EDP epochs 208, 210, and 212 have been computed for STAs in Group 2, and the start times of EDP epochs 214, 216, 218, and 220 have been computed for STAs in Group N. In the example illustrated in FIG. 2, the EDP epochs for each EDP group are of different lengths, but in some embodiments, the EDP epochs may be the same duration. In addition, the EDP epochs for a single EDP group may be of different durations.

At the beginning of each EDP epoch, there is a transitory period in which each STA is associated with two AIDs (i.e., an AID from the previous EDP epoch for received data units and an AID from the current EDP epoch for transmitted data units). For example, transitory period 222 occurs at the beginning of EDP epoch 204. During transitory period, AID values assigned during EDP epoch 202, and AID values assigned during epoch 204 may be used for STAs in Group 1. In a regular case (i.e., during a time when no transitory period is occurring), each STA in the groups is associated with a single AID and, therefore, 250 AIDs have been assigned to stations are being used (125 STAs in Group 1 + 75 STAs in Group 2 + 50 STAs in Group N = 250 AIDs). If there are, for example, 2000 AIDs to choose from in an AID pool and 250 AIDs have been assigned to stations, there are 1750 AIDs left to use for assigning to STAs in the next EDP epoch.

During time t2, the STAs in Group 1 are in a transitory period 222 at the beginning of EDP epoch 204 and, therefore, each STA in Group 2 is associated with two AIDs. Therefore, as illustrated in FIG. 2, at time t2, 375 AIDs are being used (2 AIDs x (125 STAs in Group 1) + 75 STAs in Group 2 + 50 STAs in Group N = 375 AIDs). In a similar manner, at time t3, the STAs in Group N are in a transitory period 224 at the beginning of EDP epoch 218 and each STA in Group N is associated with two AIDs. Therefore, at time t3, 300 AIDs are being used (125 STAs in Group 1 + 75 STAs in Group 2 + 2 AIDs x (50 STAs in Group N) = 300 AIDs). As illustrated, during a transitory period, since some of the STAs are associated with two AIDs, the total number of AIDs being used is increased and the total number of available (unused) AIDs to choose from decreases. For example, if there are 2000 AIDS to choose from, at time t2, there are 1625 AIDs left to use for assigning to STAs in the next EDP epoch and, at time t3, there are 1700 AIDs left to use for assigning to STAs in the next EDP epoch.

As discussed above, in some situations, transitory periods for multiple groups may overlap. For example, as illustrated in FIG. 2, at time t1, transitory periods overlap for Group 2 (at the beginning of EDP epoch 210) and Group N (at the beginning of EDP epoch 216). Therefore, at time t1, STAs in Group 2 and Group N are associated with two AIDs. In this case, at time t1, 375 AIDs are being used (125 STAs in Group 1 + 2 AIDs x (75 STAs in Group 2) + 2 AIDs x (50 STAs in Group N) = 375 AIDs). If there are 2000 AIDS to choose from, at time t1, there are 1625 AIDs left to use for assigning to STAs in the next EDP epoch.

At time t4, transitory periods overlap for Group 1 (at the beginning of EDP epoch 206), Group 2 (at the beginning of EDP epoch 212) and Group N (at the beginning of EDP epoch 220). Therefore, at time t4, STAs in Group 1, Group 2, and Group N are associated with two AIDs. In this case, at time t4, 500 AIDs are being used (2 AIDs x (125 STAs in Group 1) + 2 AIDs x (75 STAs in Group 2) + 2 AIDs x (50 STAs in Group N) = 500 AIDs being used). If there are 2000 AIDS to choose from, at time t4, there are 1500 AIDs left assigning to STAs in the next EDP epoch.

As illustrated in FIG. 2, overlapping transitory periods among EDP groups may become a problem if there is a large number of STAs in the EDP groups. If an overlap in transitory periods occurs for a large enough number of stations, AP operations may be impacted, potentially causing a DoS (Denial of Service). In addition, the problem of overlapping transitory periods limits the ability of the AP to scale wireless access support.

Reference is now made to FIG. 3. FIG. 3 is a graph 300 illustrating simulation results of available AIDs for assigning to 150 STAs if the full AID pool is 500 elements.

In graph 300, plot 302 illustrates an example in which the AIDs are not rotated and, therefore, there are no transitory periods. In this case, if the full AID pool includes 500 AIDs and each of the 150 STAs is assigned a single AID, 350 AIDs are still available. Plot 304 illustrates an example in which the 150 STAs are divided into 10 EDP groups of 15 STAs each. In this case, EDP epochs are computed for each group and transitory periods occur at the beginning of each EDP epoch. As shown by plot 304, the number of available AIDs may vary over time based on, for example, overlapping transitory periods. At point 306, for example, the number of available AIDs is approximately 230 AIDs. Therefore, the graph 300 shows that the random occurrence of EDP epoch transitory periods can impact the number of available AIDs.

Referring back to FIG. 1, to avoid a scenario in which overlapping transitory periods adversely affects a number of available AIDs, in one embodiment, AP 110 can periodically run/execute a PRF function 112 to compute the next N (e.g., 100-1000) EDP epoch start times for each group of STAs 102-1 to 102-N. For example, AP 110 may execute PRF function 112 using different input parameters so that different EDP groups have EDP epochs that ideally start at different times. As described above, when computing start times of the EDP epochs using the PRF function 112, the probability is high that an overlap in transition periods for EDP epochs in at least two groups will occur at some point.

When AP 110 computes the start times of future EDP epochs for the EDP groups, AP 110 may determine that a transitory period overlap will occur among EDP groups. When overlaps in transitory periods occur, the pool of available AIDs to assign to STAs decreases. This may be problematic if the overlap occurs for a large enough number of groups. For example, as discussed above, not having enough available AIDs to assign to STAs may negatively affect AP operations, potentially causing issues such as a DoS. AP 110 may determine that a transitory period overlap will occur for a threshold (e.g., K) number of groups such that the AID domain (e.g., the number of available AIDs to assign to STAs during the overlapping transitory period) will be adversely impacted. A number of groups in a threshold K number of groups may vary based on, for example, a number of STAs in the K groups with the overlapping transitory periods. For example, AP 110 may compute a number of EDP groups, a number of STAs in each EDP group, and the point in time of each group transitory period and may determine whether the number of AIDs needed will, at any point in time, approach or be larger than a number of available AIDs. Therefore, the threshold K may vary from time to time and K may be determined based on, for example, how many EDP groups are associated with an AP, the limit of STAs in each EDP group, that total number of STAs connected to the AP, and the maximum number of STAs the AP can associate.

When AP 110 determines that the overlap of transitory periods will occur for more than the threshold number (K) number of groups, AP 110 may send a message to STAs in K-1 groups, or a subset M<K-1 groups, to perform an action so the overlap does not occur. AP 110 may determine how many, or which groups should perform the action so that the AID domain is not adversely affected. In other words, not all groups with overlapping transitory periods need to perform an action to prevent the transitory periods from overlapping. Instead, a subset M of the groups may perform the action such that an overlap in the transitory periods may still occur for a number of groups, but the overlap may not adversely affect the available AID pool. AP 110 may determine the number of groups in (or which groups are in) the subset M based on, for example, a number of STAs in the different groups in the threshold K number of groups. The message may take the form of an action frame. In at least one embodiment, the action frame can be modelled after the proposed Collision Warning frame in the 802.11bi draft.

In the example illustrated in FIG. 1, AP 110 may have determined that an overlap in transitory periods will occur for Group 1 through Group N at time t. In this example, N may be the threshold K at which the transitory period overlap adversely affects the AID domain. AP 110 may determine that the transitory period overlap will occur at time t for the threshold K number of groups. AP 110 may determine that, if transitory periods associated with Group 1 and Group 2 do not overlap with the transitory period of Group N at time t, the AID domain will not be adversely affected. In this example, AP 110 may transmit message 120 to STAs 102-1 in Group 1 and STAs 102-2 in Group 2 with instructions to perform one or more actions to prevent the overlap in transitory periods from occurring at time t.

The STAs (e.g., STAs 102-1 in Group 1 and STAs 102-2 Group 2) may perform one or more of multiple actions to prevent the overlap in transitory periods from occurring. For example, in one embodiment, if a problematic timestamp is in the transition between two EDP epochs (e.g., EDP epoch J and EDP epoch J+1) for a given STA, the message may instruct the STA to extend epoch J to the end of epoch J+1 (hence merging the two epochs). In another embodiment, the message may instruct the STA to force the epoch change between EDP epoch J and EDP epoch J+1 to occur at an earlier or later time. In this embodiment, a length of EDP epoch J may be shortened or lengthened so that the transitory period at the beginning of epoch J+1 does not occur at time t. In yet another embodiment, AP 110 may instruct the STA to not change its AID at the start of epoch J+1. In this embodiment, the STA may maintain the same AID for two consecutive EDP epochs (e.g., epoch J and epoch J+1).

In another embodiment, the AP 110 may send an action frame to the STAs with a message requesting the STAs to recompute the PRF to change some input parameters of the PRF. If one or more parameters (e.g., the key or seed) of the PRF is changed, the computation of the start times of the EDP epochs will change. Because of the re-computation, with parameters provided by the AP 110, the occurrence of the collision of the transitory periods can be postponed long enough into the future. If an additional collision of transitory periods is to occur in the future, AP 110 may determine whether the additional collision will occur for a threshold number of groups that will adversely affect the AID domain and AP 110 may transmit message 120 to prevent the collision from occurring for at least some of the threshold number of groups.

In some embodiments, the same message is transmitted to each STA in a group so that each STA in the group performs the same action. In some embodiments, different messages may be transmitted to STAs in different groups so that STAs in different groups perform different actions or perform the same action with different parameters. For example, the message 120 may instruct different groups to shorten or lengthen an EDP epoch by a different amount or to recalculate the start times of one or more EDP epochs using different parameters.

In some embodiments, the message 120 may be an action frame. For example, the action frame may be an isolated action frame or an information element (IE) within other frames exchanged between AP 110 and STAs 102-1 to 102-N. In another embodiment, the AP 110 may send a list of EDP groups that need re-computing through a spelled-out list, a bitmap, or a Bloom Filter in a broadcast message (even in the beacon).

The STAs 102-1 and 102-2 may perform the one or more actions in the message transmitted by the AP 110 to prevent the overlap in the transitory period from occurring for the STAs in Groups 1 and 2. By preventing the overlaps in transitory periods from occurring, the pool of available AIDs to assign to STAs remains large enough to effectively rotate the AIDs for the STAs without adversely affecting AP operations.

Accordingly, embodiments herein may provide techniques to allow APs to control the AID domain space that may be impacted by EDP transitory periods overlapping across EDP groups.

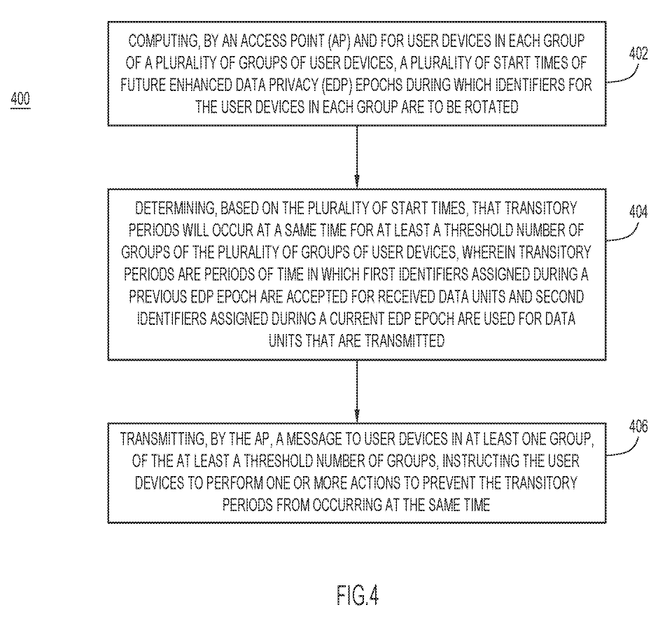

Reference is now made to FIG. 4. FIG. 4 is a flow chart of a method 400 of performing one or more actions to prevent transitory periods in a plurality of EDP groups from occurring at the same time. Method 400 may be performed, for example, by AP 110 in conjunction with STAs 102-1 to 102-N.

At 402, an AP computes, for user devices in each group of a plurality of groups of user devices, a plurality of start times of future EDP epochs during which identifiers from the user devices in each group are to be rotated. In one embodiment, the identifiers may include AIDs associated with the user devices. For example, AP 110 may compute start times of EDP epochs 202, 204, and 206 of FIG. 2 for stations in Group 1, start times of EDP epochs 208, 210, and 212 for stations in Group 2, and start times of EDP epochs 214, 216, and 218 for stations in Group N. As described above, the start times of future EDP epochs may be determined using a PRF.

At 404, it is determined, based on the plurality of start times, that transitory periods will occur at a same time for at least a threshold number of groups of the plurality of groups of user devices. The transitory periods are periods of time in which first identifiers assigned during a previous EDP epoch are accepted for received data units and second identifiers assigned during a current EDP epoch are used for data units that are to be transmitted. For example, as described with respect to FIG. 2, AP 110 may determine that, at time t4, transitory periods will occur at the same time for Group 1 (e.g., at the beginning of EDP epoch 206), Group 2 (e.g., at the beginning of EDP epoch 212), and Group N (e.g., at the beginning of EDP epoch 220). In this example, N may be greater than or equal to the threshold number of groups.

At 406, the AP transmits a message to user devices in at least one group, of the at least a threshold number of groups, instructing the user devices to perform one or more actions to prevent the transitory periods from occurring at the same time. For example, as described above with respect to FIG. 1, AP 110 may transmit message 120 to stations in a subset (e.g., Groups 1 and 2) of the N Groups. In one embodiment, the actions may include extending an ending of a first EDP epoch to coincide with an ending of a second EDP epoch associated with the transitory period to merge the first EDP epoch and the second EDP epoch. In another embodiment, the actions may include changing a start time of an EDP epoch associated with a transitory period to an earlier time or a later time. In yet another embodiment, the actions may include recomputing at least one of the plurality of start times of the future EDP epochs using a PRF and parameters provided by the AP. Stations in the subset of the N groups (e.g., STAs 102-1 and 102-2) may perform the one or more actions to prevent the overlap in transitory periods from occurring for stations in the subset of the N groups.

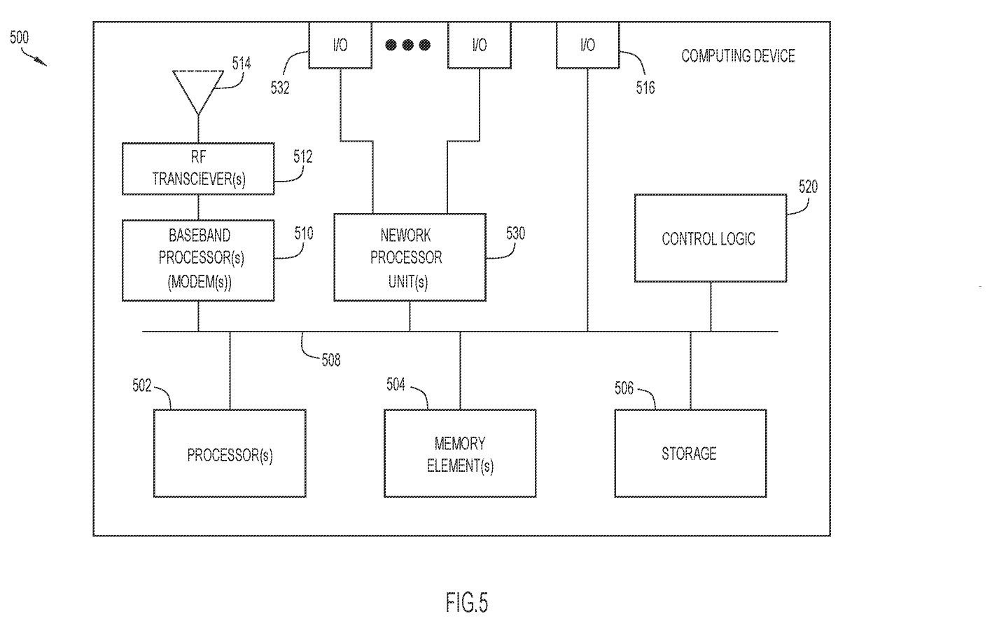

Referring to FIG. 5, FIG. 5 illustrates a hardware block diagram of a computing device 500 that may perform functions associated with operations discussed herein in connection with the techniques described for embodiments herein. In various embodiments, a computing device or apparatus, such as computing device 500 or any combination of computing devices 500, may be configured as any entity/entities in order to perform operations of the various techniques discussed for embodiments herein, such as any elements, functions, etc. discussed for embodiments herein (e.g., an AP, a STA, etc.).

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. In various embodiments, instructions associated with logic for computing device 500 can overlap in any manner and are not limited to the specific allocation of instructions and/or operations described herein.

Computing device 500 may further include at least one baseband processor or modem 510, one or more radio RF transceiver(s) 512 (e.g., any combination of RF receiver(s) and RF transmitter(s)), one or more antenna(s) or antenna array(s) 514 (which may be inclusive of software-defined antenna(s) or antenna array(s) in accordance with embodiments herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a method is provided including computing, by an access point (AP) and for user devices in each group of a plurality of groups of user devices, a plurality of start times of future enhanced data privacy (EDP) epochs during which identifiers for the user devices in each group are to be rotated; determining, based on the plurality of start times, that transitory periods will occur at a same time for at least a threshold number of groups of the plurality of groups of user devices, wherein the transitory periods are periods of time in which first identifiers assigned during a previous EDP epoch are accepted for received data units and second identifiers assigned during a current EDP epoch are used for data units that are transmitted; and transmitting, by the AP, a message to user devices in at least one group of the at least a threshold number of groups instructing the user devices to perform one or more actions to prevent the transitory periods from occurring at the same time.

In one example, the identifiers include association identifiers (AIDs). In another example, the message includes instructions to extend an ending of a first EDP epoch to coincide with an ending of a second EDP epoch associated with a transitory period of the transitory periods to merge the first EDP epoch and the second EDP epoch. In another example, the message includes instructions to change a start time of an EDP epoch associated with a particular transitory period of the transitory periods to an earlier time or a later time. In another example, computing the plurality of start times includes computing the plurality of start times using a pseudo-random function (PRF).

In another example, the instructions include instructions to recompute at least one of the plurality of start times of the future EDP epochs using the PRF, and wherein the message includes parameters for recomputing the at least one of the plurality of start times. In another example, transmitting the message includes broadcasting, by the AP, the message to the user devices in the at least one group. In another example, the message is an action frame. In another example, the message is an information element in a frame exchanged between the AP and the user devices in the at least one group.

In another form, a system is provided that includes a communications interface; a memory storing instructions; and one or more processors, wherein the one or more processors are configured to execute the instructions to perform operations including: computing, for user devices in each group of a plurality of groups of user devices, a plurality of start times of future enhanced data privacy (EDP) epochs during which identifiers for the user devices in each group are to be rotated; determining, based on the plurality of start times, that transitory periods will occur at a same time for at least a threshold number of groups of the plurality of groups of user devices, wherein the transitory periods are periods of time in which first identifiers assigned during a previous EDP epoch are accepted for received data units and second identifiers assigned during a current EDP epoch are used for data units that are transmitted; and transmitting, via the communications interface, a message to user devices in at least one group of the at least a threshold number of groups instructing the user devices to perform one or more actions to prevent the transitory periods from occurring at the same time.

In yet another form, one or more non-transitory computer readable storage media encoded with instructions are provided that, when executed by a processor of an access point device associated with a wireless local area network (WLAN), cause the processor to execute a method including: computing, for user devices in each group of a plurality of groups of user devices, a plurality of start times of future enhanced data privacy (EDP) epochs during which identifiers for the user devices in each group are to be rotated; determining, based on the plurality of start times, that transitory periods will occur at a same time for at least a threshold number of groups of the plurality of groups of user devices, wherein the transitory periods are periods of time in which first identifiers assigned during a previous EDP epoch are accepted for received data units and second identifiers assigned during a current EDP epoch are used for data units that are transmitted; and transmitting a message to user devices in at least one group of the at least a threshold number of groups instructing the user devices to perform one or more actions to prevent the transitory periods from occurring at the same time.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly be connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
computing, by an access point (AP) and for user devices in each group of a plurality of groups of user devices, a plurality of start times of future enhanced data privacy (EDP) epochs during which identifiers for the user devices in each group are to be rotated;
determining, based on the plurality of start times, that transitory periods will occur at a same time for at least a threshold number of groups of the plurality of groups of user devices, wherein the transitory periods are periods of time in which first identifiers assigned during a previous EDP epoch are accepted for received data units and second identifiers assigned during a current EDP epoch are used for data units that are transmitted; and
transmitting, by the AP, a message to user devices in at least one group of the at least a threshold number of groups instructing the user devices to perform one or more actions to prevent the transitory periods from occurring at the same time.

2. The method of claim 1, wherein the identifiers include association identifiers (AIDs).

3. The method of claim 1, wherein the message includes instructions to extend an ending of a first EDP epoch to coincide with an ending of a second EDP epoch associated with a transitory period of the transitory periods to merge the first EDP epoch and the second EDP epoch.

4. The method of claim 1, wherein the message includes instructions to change a start time of an EDP epoch associated with a particular transitory period of the transitory periods to an earlier time or a later time.

5. The method of claim 1, wherein computing the plurality of start times includes computing the plurality of start times using a pseudo-random function (PRF).

6. The method of claim 5, wherein the instructions include instructions to recompute at least one of the plurality of start times of the future EDP epochs using the PRF, and wherein the message includes parameters for recomputing the at least one of the plurality of start times.

7. The method of claim 1, wherein transmitting the message includes broadcasting, by the AP, the message to the user devices in the at least one group.

8. The method of claim 1, wherein the message is an action frame.

9. The method of claim 1, wherein the message is an information element in a frame exchanged between the AP and the user devices in the at least one group.

10. A system comprising:
a communications interface;
a memory storing instructions; and
one or more processors, wherein the one or more processors are configured to execute the instructions to perform operations comprising:
computing, for user devices in each group of a plurality of groups of user devices, a plurality of start times of future enhanced data privacy (EDP) epochs during which identifiers for the user devices in each group are to be rotated;
determining, based on the plurality of start times, that transitory periods will occur at a same time for at least a threshold number of groups of the plurality of groups of user devices, wherein the transitory periods are periods of time in which first identifiers assigned during a previous EDP epoch are accepted for received data units and second identifiers assigned during a current EDP epoch are used for data units that are transmitted; and
transmitting, via the communications interface, a message to user devices in at least one group of the at least a threshold number of groups instructing the user devices to perform one or more actions to prevent the transitory periods from occurring at the same time.

11. The system of claim 10, wherein the identifiers include association identifiers (AIDs).

12. The system of claim 10, wherein the message includes instructions to extend an ending of a first EDP epoch to coincide with an ending of a second EDP epoch associated with a transitory period of the transitory periods to merge the first EDP epoch and the second EDP epoch.

13. The system of claim 10, wherein the message includes instructions to change a start time of an EDP epoch associated with a particular transitory period of the transitory periods to an earlier time or a later time.

14. The system of claim 10, wherein the operation of computing the plurality of start times includes computing the plurality of start times using a pseudo-random function (PRF).

15. The system of claim 14, wherein the instructions include instructions to recompute at least one of the plurality of start times of the future EDP epochs using the PRF, and wherein the message includes parameters for recomputing the at least one of the plurality of start times.

16. The system of claim 10, wherein the operation of transmitting the message includes broadcasting the message to the user devices in the at least one group.

17. The system of claim 10, wherein the message is an action frame.

18. One or more non-transitory computer readable storage media encoded with instructions that, when executed by a processor of an access point device associated with a wireless local area network (WLAN), cause the processor to execute a method comprising:
computing, for user devices in each group of a plurality of groups of user devices, a plurality of start times of future enhanced data privacy (EDP) epochs during which identifiers for the user devices in each group are to be rotated;
determining, based on the plurality of start times, that transitory periods will occur at a same time for at least a threshold number of groups of the plurality of groups of user devices, wherein the transitory periods are periods of time in which first identifiers assigned during a previous EDP epoch are accepted for received data units and second identifiers assigned during a current EDP epoch are used for data units that are transmitted; and
transmitting a message to user devices in at least one group of the at least a threshold number of groups instructing the user devices to perform one or more actions to prevent the transitory periods from occurring at the same time.

19. The one or more non-transitory computer readable storage media of claim 18, wherein the message includes instructions to extend an ending of a first EDP epoch to coincide with an ending of a second EDP epoch associated with a transitory period of the transitory periods to merge the first EDP epoch and the second EDP epoch.

20. The one or more non-transitory computer readable storage media of claim 18, wherein the message includes instructions to change a start time of an EDP epoch associated with a particular transitory period of the transitory periods to an earlier time or a later time.
